(19) United States
(12) Patent Application Publication
(10) Pub. No.: US 2026/0340881 A1
(43) Pub. Date: Oct. 29, 2026

(54) METHOD OF ENCODING/DECODING GAUSSIAN SPLAT AND COMPUTER READABLE RECORDING MEDIUM STORING INSTRUCTIONS FOR PERFORMING THE ENCODING METHOD

(71) Applicant: Electronics and Telecommunications Research Institute, Daejeon (KR)

(72) Inventors: Kwan Jung OH, Daejeon (KR); Gwangsoon LEE, Daejeon (KR); Ho Sung JEON, Daejeon (KR); Adrian DZIEMBOWSKI, Poznan (PL); Blazej SZYDELKO, Poznan (PL)

(73) Assignee: Electronics and Telecommunications Research Institute, Daejeon (KR)

(21) Appl. No.: 19/576,132

(22) Filed: Mar. 24, 2026

(30) Foreign Application Priority Data
Mar. 24, 2025 (KR) 10-2025-0037601
Jun. 25, 2025 (KR) 10-2025-0084526
Sep. 30, 2025 (KR) 10-2025-0143094
Dec. 9, 2025 (KR) 10-2025-0194484
Jan. 19, 2026 (KR) 10-2026-0010401
Jan. 21, 2026 (KR) 10-2026-0012117

(51) Int. Cl. G06T 9/00; G06T 15/08

(52) U.S. Cl. CPC G06T 9/001; G06T 15/08

(57) ABSTRACT

A method of encoding a Gaussian Splat for representing 3D space according to a present disclosure comprises converting rotation information composed of four components of a Gaussian Splat (GS) into three components; and encoding data including the three components. Here, the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.

### BACKGROUND OF THE INVENTION

### Field of the Invention

The present disclosure related to a method of encoding/decoding a gaussian splat for 3D space representation.

### Description of the Related Art

3D Gaussian splatting is a technology that models the radiance field of a 3D space as a collection of 3D Gaussians, rendering the 3D space into a 2D image. Each GS (Gaussian Splat) consists of multiple attribute information, and the amount of data per GS is enormous. Consequently, various studies are currently underway to effectively compress the data representing the GS.

### SUMMARY OF THE INVENTION

An object of the present disclosure is to provide a method for encoding and decoding attributes of Gaussian splats (GSs) for representing a 3D space.

An object of the present disclosure is to provide a method for encoding and decoding rotation information of Gaussian splats (GSs) by normalizing the rotation information.

An object of the present disclosure is to provide a method for encoding and decoding information indicating, for each attribute, a codec type used to encode and decode the corresponding attribute.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding a Gaussian splat for 3D space representation, the method comprising converting rotation information composed of four components of a Gaussian Splat (GS) into three components; and encoding data including the three components. Here, the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.

In the method of encoding a Gaussian splat for 3D space representation according to the present disclosure, the three components comprises a converted x component, a converted y component and a converted z component.

In the method of encoding a Gaussian splat for 3D space representation according to the present disclosure, information indicates whether the x component, the y component and the z component are normalized by the w component.

In the method of encoding a Gaussian splat for 3D space representation according to the present disclosure, a normalization is performed by dividing each value of the x component, the y component and the z component by the w component.

In the method of encoding a Gaussian splat for 3D space representation according to the present disclosure, converting the four components into the three components comprises selecting, from a plurality of rotation candidates, a rotation candidate having the greatest value of the w component.

In the method of encoding a Gaussian splat for 3D space representation according to the present disclosure, the plurality of rotation candidates comprises at least one of no rotation, a 90-degree rotation about an x-axis, a 90-degree rotation about a y-axis, or a 90-degree rotation about a z-axis, and when a rotation candidate involving rotation is selected, a scale transformation is performed to preserve a shape of the Gaussian splat.

In the method of encoding a Gaussian splat for 3D space representation according to the present disclosure, a value of w is encoded as a constant value.

In the method of encoding a Gaussian splat for 3D space representation according to the present disclosure, information indicating a number of dimensions of the rotation information is encoded and signaled, and the information has a value equal to a value subtracting a pre-defined constant value from a number of components constituting the rotation information.

According to method of decoding a Gaussian splat for 3D space representation of the present disclosure, the method comprising decoding data corresponding to rotation information composed of three components; and restoring four components of the rotation information from decoded three components. Here, the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.

In the method of decoding a Gaussian splat for 3D space representation according to the present disclosure, the decoded three components comprise a decoded x component, a decoded y component and a decoded z component.

In the method of decoding a Gaussian splat for 3D space representation according to the present disclosure, information indicating whether the decoded x component, the decoded y component and the decoded z component are normalized.

In the method of decoding a Gaussian splat for 3D space representation according to the present disclosure, when the information indicating that the decoded x component, the decoded y component and the decoded z component are normalized, the x component, the y component and the z component is derived by multiplying the w component to the decoded x component, the decoded y component and the decoded z component, respectively.

In the method of decoding a Gaussian splat for 3D space representation according to the present disclosure, the w component is an inverse of a square root of a sum of a square of the decoded x component, a square of the decoded y component, a square of the decoded z component, and a pre-defined constant value.

In the method of decoding a Gaussian splat for 3D space representation according to the present disclosure, when the information indicates that the decoded x component, the decoded y component and the decoded z component are not normalized, the decoded x component, the decoded y component, and the decoded z component are set as the x component, the y component, and the z component, respectively.

In the method of decoding a Gaussian splat for 3D space representation according to the present disclosure, the w component w is a square root of a value obtained by subtracting a sum of a square of the decoded x component, a square of the decoded y component, and a square of the decoded z component from a predetermined constant.

In the method of decoding a Gaussian splat for 3D space representation according to the present disclosure, the w has a constant value.

Meanwhile, in the present disclosure, it is possible to provide a computer-readable recording medium recording instructions for implementing the method of encoding/decoding a Gaussian splat for 3D space representation.

### BRIEF DESCRIPTION OF THE DRAWINGS

FIG. 1 shows GS information obtained through multi-view images and a virtual viewpoint rendered based thereon.

FIG. 2 is a diagram illustrating a plurality of attributes constituting a GS.

FIG. 3 shows an example in which the attributes of GSs are represented as 2D images.

FIG. 4 illustrates a block diagram of a GS encoder and a GS decoder according to the present disclosure.

FIG. 5 illustrates 24 rotation candidates.

FIG. 6 illustrates an example of encoding/decoding rotation information of GSs according to an embodiment of the present disclosure.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

3D Gaussian Splatting (GS) is intended to enable rendering of 3D space by representing 3D space with multiple GSs. In this case, information regarding each GS is obtained through a deep learning network; to obtain GS information, image data such as multi-view images, a point cloud, or a 3D mesh may be input to the deep learning network.

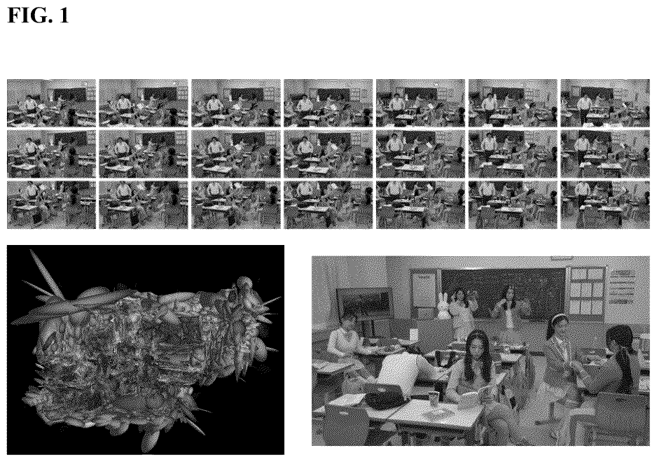

FIG. 1 shows GS information obtained through multi-view images and a virtual viewpoint rendered based thereon.

A single GS can be composed of multiple attributes.

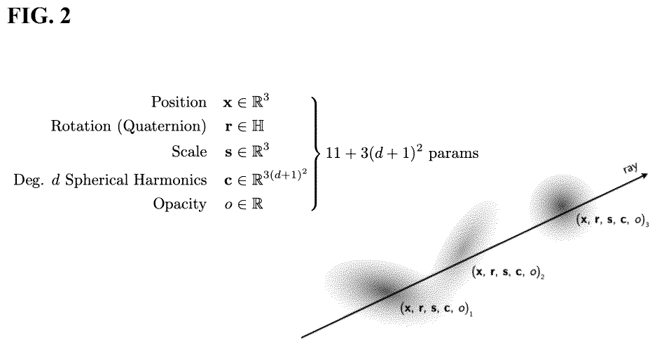

FIG. 2 is a diagram illustrating a plurality of attributes constituting a GS.

As shown in the example illustrated in FIG. 2, a GS may include at least one of position information, rotation information, size information, color information, spherical harmonics information, or opacity information. Encoding/decoding of GSs may be implemented by encoding/decoding the attributes of the GSs. In this case, to effectively encode/decode the attributes, the attributes may be represented in the form of 2D images.

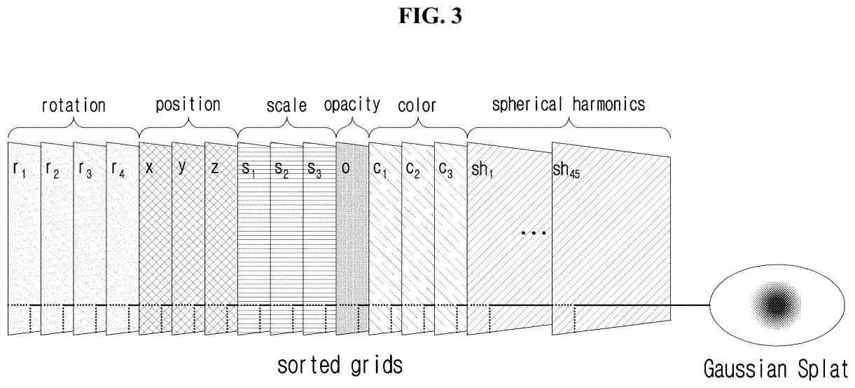

FIG. 3 shows an example in which the attributes of GSs are represented as 2D images.

Each attribute may be represented by at least one 2D image. Each attribute may be represented by as many 2D images as the number of sub-attributes (i.e., components) constituting the attribute.

For example, in the example illustrated in FIG. 3, rotation information is represented by four 2D images (r1, r2, r3, r4), position information is represented by three 2D images (x, y, z), and size information is represented by three 2D images (s1, s2, s3). Additionally, it was exemplified that opacity information is represented by a single 2D image (o), color information by three 2D images (c1, c2, c3), and spherical harmonic function information by 45 2D images (sh1, sh2, . . . sh45). Here, color information represents the zeroth-order spherical harmonic function coefficients, and spherical harmonic function information represents higher-order (i.e., greater than 0) spherical harmonic function coefficients.

Information at the same coordinates within the 2D images may correspond to the same GS. That is, by aggregating information at the same coordinates within the 2D images, the attributes of a single GS may be restored.

In other words, the resolution (i.e., number of pixels) of the 2D images may correspond to the number of GSs. For example, information at the position (10, 10) within the 2D image may represent the attribute information of the 100th GS.

GS may be represented as 2D images, and then encoded/decoded. At this time, to improve encoding compression performance, the arrangement order of the GS may be adjusted to increase the spatial correlation between the GS.

Alternatively, GS may be encoded/decoded based on Point Cloud Compression (PCC). For example, to utilize a video-based point cloud compression technique, each GS is assumed to be a point constituting the point cloud, and the geometric information and attributes of the GS may be encoded/decoded in the form of 2D images. Here, the 2D images may be encoded/decoded in an atlas format.

Specifically, the attributes of the GS may be packed to generate an atlas containing 2D images corresponding to those attributes. Additionally, each atlas containing one or more attributes is assigned a unique ID (atlasID). That is, an atlas with a specific atlasID may include at least one attribute.

Meanwhile, in order to obtain the attributes of the GSs in the decoder, mapping information is required between the coordinate system of the attributes encoded/decoded by the PCC and the coordinate system of the attributes encoded/decoded based on the atlas.

Accordingly, the encoder may encode and signal the mapping information between the coordinates within the atlas and the vertex locations of the point cloud.

Alternatively, to utilize a geometry-based point cloud compression technique, structural data of the GSs may be generated by assuming each GS as a point constituting the point cloud. Specifically, the locations of the GSs may be compressed based on at least one of octree, predictive coding, or transform coding, and other attributes may be compressed in conjunction with the locations of the GSs.

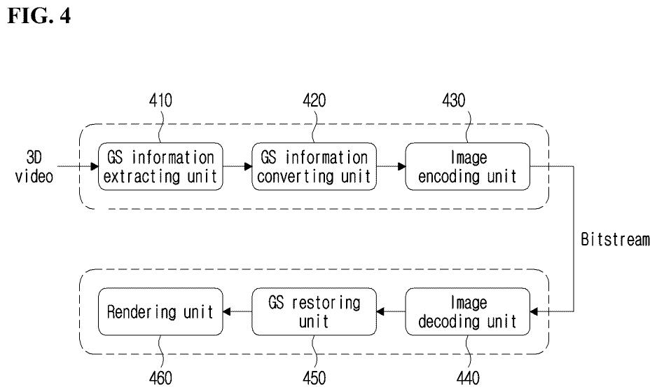

FIG. 4 illustrates a block diagram of a GS encoder and a GS decoder according to the present disclosure.

Referring to FIG. 4, the GS encoder includes a GS information extraction unit 410, a GS conversion unit 420, and an image encoding unit 430.

The GS information extraction unit 410 may extract GS information from an input image. The GS information may represent attributes of GS.

The GS conversion unit 420 performs preprocessing on the attributes of GS to process the attributes of GS into data suitable for encoding. For example, the GS conversion unit 420 may generate at least one of 2D type data or 3D structure data through preprocessing. The 2D type data may include at least one 2D image (i.e., at least one attribute).

Additionally, the GS conversion unit 420 may generate atlas and vertex-to-vertex mapping information. Mapping information may define the mapping relationship between coordinates within a 2D image and vertices within a 3D image.

The image encoding unit 430 may encode atlas, point cloud type data, and mapping information generated by the GS conversion unit 420.

Meanwhile, the image encoding unit 430 may include at least one of a 2D image encoding unit for encoding image-type data or a PCC encoding unit for encoding 3D structure data.

Meanwhile, mapping information may be expressed in the form of a 2D image and encoded through the 2D image encoding unit, or may be expressed in the form of a point cloud and encoded through the PCC encoding unit.

The GS decoder may include an image decoding unit 440, a GS restoration unit 450, and a rendering unit 460.

The image decoding unit 440 decodes at least one of a 2D image, 3D structure data, or mapping information. The image decoding unit 440 may include at least one of a 2D image decoding unit for decoding 2D images or a PCC decoding unit for decoding 3D structural data.

Meanwhile, the mapping information may be expressed in the form of a 2D image and decoded through the 2D image decoding unit, or expressed in the form of a point cloud and decoded through the PCC decoding unit.

The GS restoration unit 450 may restore the attributes of each GS based on the atlas, point cloud type data, and mapping information.

The rendering unit 460 may render the 3D space based on the restored GS.

Meanwhile, rotation information defines the orientation of the GS in 3D space. Rotation information may be expressed in a quaternion format that requires four components (i.e., channels). In other words, rotation information may be represented and compressed into four channels.

For example, when following the quaternion format, rotation information may consist of a variable w indicating the amount of rotation (i.e., angle information) and variables (x, y, z) indicating the orientation information of the rotation axis. Here, the variable x indicates the x component in the direction of the rotation axis, the variable y indicates the y component in the direction of the rotation axis, and the variable z indicates the z component in the direction of the rotation axis.

By expressing rotation information in a quaternion format, the orientation of the GS may be manipulated more stably and efficiently. In particular, expressing rotation information in a quaternion format enables the accurate representation and rendering of 3D scenes. However, image compression is generally designed considering three color channels (e.g., RGB). Consequently, when rotation information is expressed in a quaternion format having four channels, there is a problem in that it is difficult to utilize general image compression tools. For example, when rotation information in a quaternion format having four channels is compressed using four mono image encoders and four mono image decoders, the number of required encoders and decoders becomes excessively large.

To resolve the above problem, the present disclosure proposes a rotation information compression method that is friendly to conventional image compression tools. Specifically, the present disclosure proposes a method of converting rotation information in a quaternion format requiring four components into three components in order to increase the compression efficiency of rotation information.

For example, rotation information in a quaternion format requiring four components may be converted into a format requiring three components. Here, a format requiring three components may include at least one of the following: Euler format, Axis-Angle format, Rodrigues Vector (Rotation Vector) format, Lie Algebra (Exponential Map) format, Modified Rodrigues Parameters (MRP) format, Cardan Angles (Tait-Bryan Angles) format, or Euler-Rodrigues Parameters format.

For example, rotation information (w, x, y, z) in a quaternion format expressed in four components may be converted into rotation information (ψ, θ, φ) in an Euler format expressed in three components. For example, based on the following Equation 1, rotation information in a 32-bit quaternion format may be converted into rotation information in a 32-bit Euler format.

Yaw(ψ)=arctan 2(2(wz+xy),1−2(y²+z²))

Pitch(θ)=arcsin(2(wy−zx))

Roll(φ)=arctan 2(2(wx+yz),1−2(x²+y²)) [Equation 1]

In the above equation 1, the variable ψ represents the degree of rotation about the x-axis (i.e., roll), the variable θ represents the degree of rotation about the y-axis (i.e., pitch), and the variable φ represents the degree of rotation about the z-axis (i.e., yaw).

Quantization and inverse quantization may be applied to rotation information converted into Euler format. For example, in an encoder, rotation information in Euler format represented by 32 bits may be quantized to obtain 8-bit quantized rotation information. In a decoder, rotation information in Euler format may be restored by performing inverse quantization on the 8-bit quantized rotation information.

Subsequently, the restored rotation information in Euler format may be converted back into rotation information in quaternion format. For example, in a decoder, 32-bit Euler format rotation information may be restored to 32-bit quaternion format rotation information based on the following equation 2.

$$w = cos ( \frac{ϕ}{2} ) cos ( \frac{θ}{2} ) cos ( \frac{ψ}{2} ) + sin ( \frac{ϕ}{2} ) sin ( \frac{θ}{2} ) sin ( \frac{ψ}{2} )$$

$$x = sin ( \frac{ϕ}{2} ) cos ( \frac{θ}{2} ) cos ( \frac{ψ}{2} ) - cos ( \frac{ϕ}{2} ) sin ( \frac{θ}{2} ) sin ( \frac{ψ}{2} )$$

$$y = cos ( \frac{ϕ}{2} ) sin ( \frac{θ}{2} ) cos ( \frac{ψ}{2} ) + sin ( \frac{ϕ}{2} ) cos ( \frac{θ}{2} ) sin ( \frac{ψ}{2} )$$

$$𝓏 = cos ( \frac{ϕ}{2} ) cos ( \frac{θ}{2} ) sin ( \frac{ψ}{2} ) - sin ( \frac{ϕ}{2} ) sin ( \frac{θ}{2} ) cos ( \frac{ψ}{2} )$$

Rotation information in quaternion format may also be converted into a 3-channel format different from the Euler format. For example, when the Axis-Angle format is used, rotation information may be expressed as a single rotation axis and a single rotation angle. Alternatively, when the Rodrigues Vector (Rotation Vector) format is used, rotation information may be expressed by multiplying the rotation axis vector by an angle. Alternatively, when the Lie Algebra (Exponential Map) format is used, rotation information may be expressed in vector form by combining the rotation axis and the angle. Alternatively, when the Modified Rodrigues Parameters (MRP) format is used, rotation information may be expressed as three values by combining the axis and the angle. Alternatively, when the Cardan Angles (Tait-Bryan Angles) format is used, rotation information may be expressed as rotations along three orthogonal axes. Alternatively, when the Euler-Rodrigues Parameters format is used, rotation information may be expressed as parameters based on the axis and the angle.

In general, GS information has symmetry. This means that a GS rotated by (180+α) degrees and a GS rotated by α degrees may be treated identically.

Therefore, if rotation information expressed in quaternion format is converted into three channels that include the angle, the number of channels for encoding/decoding may be reduced by one. Furthermore, by utilizing symmetry, the bit depth of the information expressed by an angle may also be reduced.

For example, assume that values in the range of −π to π are mapped to pixel values in the range of 0 to 255. In this case, by utilizing the symmetry of GS, the angle of the GS may be represented using only values in the range of −π to 0. Accordingly, the bit depth for representing the angle may be reduced by 1 bit, or the precision of the angle representation may be doubled.

In this way, the compression efficiency of rotation information may be improved by utilizing the symmetry of GS. In order to enable the decoder to recover rotation information in a quaternion format, conversion information of the rotation information may be encoded and signaled.

For example, at least one of information indicating whether 4-channel rotation information has been converted to 3 channels, information indicating one of the formats having 3 channels, or mapping information between the 3 channels and components may be encoded and signaled.

Meanwhile, if a conversion that results in loss of color components is used, such as the YUV4:2:0 or YUV4:2:2 color format, information indicating the color format may also be encoded and signaled.

It may also be considered to reduce the number of components representing rotation information while maintaining the quaternion format. Specifically, in rotation information in a quaternion format composed of four components, rotation information composed of three components may be derived by removing a variable w indicating a rotation angle. For convenience of description, the components constituting the rotation information in the quaternion format will be referred to as quaternion components.

When following the quaternion format, the rotation of GS does not change even if the scale of the rotation information (x, y, z, w) is changed. For example, under the quaternion format, rotation information (1, 2, 3, 4) may be treated identically to rotation information (2, 4, 6, 8). Based on the above characteristics, the four quaternion components may be converted into three components by removing the variable w representing the amount of rotation, or by adjusting other variables (i.e., x, y, z) based on the variable w representing the amount of rotation. Specifically, if the four quaternion components are normalized by w, the rotation information may be changed as (x/w, y/w, z/w, w/w). That is, for all GSs, when the value of the w component is normalized to 1 (i.e., w/w), the rotation information of the GSs may be represented using three components (x/w, y/w, z/w).

However, when the value of the variable wis close to zero, a problem may occur in that the values of the three components become excessively large. In particular, when the value of the variable w is zero, a problem occurs where the rotation information of the GSs cannot be expressed using three components. To resolve this problem, three quaternion components (x/w, y/w, z/w) may be derived based on the four quaternion components (x, y, z, w) derived by rotating the GS by 90 degrees about at least one of the x-axis, y-axis, or z-axis. Meanwhile, the encoder may select one of a plurality of rotation candidates. Specifically, the encoder may select the rotation candidate among the plurality of rotation candidates in which the value of variable w is maximized.

The plurality of rotation candidates may include at least one of no rotation, a 90-degree rotation about the x-axis, a 90-degree rotation about the y-axis, or a 90-degree rotation about the z-axis.

Alternatively, the plurality of rotation candidates may further include, in addition to the above rotation candidates, at least one of a −90-degree rotation about the x-axis, a −90-degree rotation about the y-axis, or a −90-degree rotation about the z-axis.

Alternatively, the plurality of rotation candidates may include a greater number of rotation candidates than those described above.

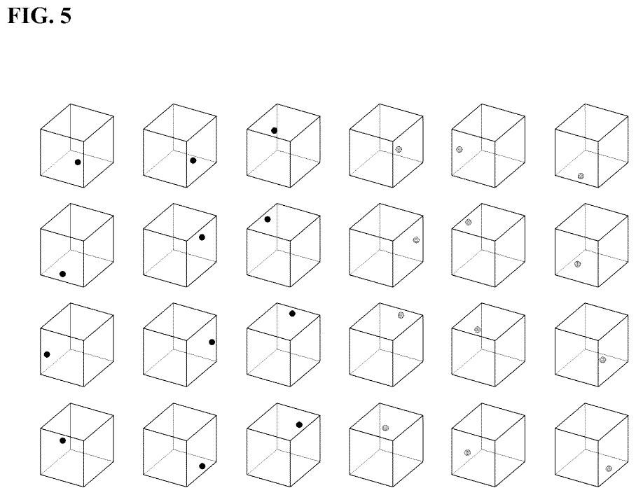

FIG. 5 illustrates 24 rotation candidates.

By utilizing more rotation candidates, W may have a larger value.

Rotation of a GS may be performed by interchanging scale components with each other. For example, when the GS is rotated by 90 degrees about the x-axis, a scale factor sx for the x component may be exchanged with a scale factor sz for the z component.

As another example, the encoder may convert four components in quaternion format into three components in quaternion format only when the value of variable w is greater than a threshold value. If the value of variable w is equal to or less than the threshold value, the encoder may convert four components in quaternion format into three components in non-quaternion format.

Meanwhile, if the value of w is 1, there is no need to divide the other components (i.e., x, y, and z) by w. Accordingly, whether to perform normalization by w may be determined adaptively.

Meanwhile, even when the GS is rotated, the shape of the corresponding GS may remain unchanged through scale transformation.

To restore the rotation information in the decoder, the transformation information of the rotation information may be encoded and signaled. As an example, Table 1 illustrates a high-level syntax structure containing the transformation information of the rotation information.

TABLE 1

gs_attribute_property( payloadSize ) {

gap_rotation_property_present_flag
if(gap_rotation_property_present_flag){

gap_normalized_rotation_flag
gap_num_rotation_components_minus3
gap_rotation_component_order

}

In Table 1, the syntax gap_rotation_property_present_flag indicates whether the bitstream includes rotation information. A syntax gap_rotation_property_present_flag of 1 indicates that the bitstream includes syntaxes for restoring rotation information (i.e., syntax gap_num_rotation_components and syntax gap_rotation_component_order). Conversely, a syntax gap_rotation_property_present_flag of 0 indicates that the bitstream does not include syntaxes for restoring rotation information.

The default value of the syntax gap_rotation_property_present_flag may be 0. That is, when the bitstream does not include the syntax gap_rotation_property_present_flag, the value thereof is inferred as 0. Additionally, if the syntax gap_rotation_property_present_flag is 1, an image (i.e., a 2D image) in which an attribute indicates rotation information (i.e., ATTR_ROTATION) must be included in the bitstream.

The syntax gap_normalized_rotation_flag indicates whether the component values of the rotation information are normalized. Specifically, a syntax gap_normalized_rotation_flag of 1 indicates that the component values of the rotation information decoded from the bitstream are normalized. Conversely, a syntax gap_normalized_rotation_flag of 0 indicates that the component values of the rotation information decoded from the bitstream are not normalized.

When the syntax gap_normalized_rotation_flag is not present, the value thereof may be inferred as 1.

The syntax gap_num_rotation_components_minus3 indicates the number of components constituting the rotation information (i.e., the number of dimensions of the rotation information). Specifically, the value obtained by adding 3 to the syntax gap_num_rotation_component_minus3 may be the dimension of the rotation information. For example, a syntax gap_num_rotation_component_minus3 of 0 indicates that the rotation information consists of 3 rotation information components. That is, this indicates that 4 quaternion components have been converted into 3 components (e.g., 3 quaternion components or 3 Euler components) and encoded/decoded. On the other hand, a syntax gap_num_rotation_component_minus3 of 1 indicates that the rotation information consists of 4 rotation information components. This indicates that the 4 converted quaternion components have been encoded/decoded as they are. That is, the 4 converted quaternion components (x/w, y/w, z/w, 1) may be encoded/decoded as they are. Meanwhile, w, converted to 1, is a constant and does not need to be encoded or decoded during the encoding/decoding process. That is, the value may be set to 1 in the decoder while omitting the encoding/decoding of the syntax indicating the w value.

Alternatively, the encoder may explicitly encode/decode the value of w. This may be for uniformly processing four pieces of rotation information. That is, when normalization is performed, the value of w is fixed to 1, and thus almost no additional compressed bitstream is generated even if the value of w is encoded/decoded. Accordingly, as in the conventional method, the four quaternion components may be encoded/decoded as they are, while the value of w is fixed to a constant value of 1 and the remaining components are encoded/decoded using values normalized by w.

When the syntax element gsd_num_rotation_components_minus3 is not present, the value thereof may be inferred to be 0.

Meanwhile, the number of dimensions indicated by the syntax gsd_num_rotation_components_minus3 shall have the same value as the number of dimensions indicated by the syntax ai_attribute_dimension_minus1[atlasID][i] for a 2D image in which attribute i in an atlas identified by atlasID represents rotation information.

The syntax gap_rotation_component_order indicates a mapping order between attribute components and rotation components. When the syntax element gap_rotation_component_order is not present, the value thereof may be inferred to be 0.

In Table 1, the rotation information transformation information is exemplified as being included in an attribute property structure of a GS. As another example, some of the rotation information transformation information and syntax elements may be included in the attribute property structure of the GS, while the remaining information and syntax elements may be included in a quantization structure of the GS. Tables 2 and 3 illustrate examples in which the rotation information transformation information is distributed across the attribute property structure and the quantization structure of the GS.

TABLE 2

| | Descriptor |
|---|---|
| gs_dequantization( payloadSize ) { | |
| ... | |
| gsd_rotation_present_flag | u(1) |
| if( gsd_rotation_present_flag ){ | |
| gsd_rotation_dimension_minus1 | |
| for( i = 0; i < | |
| gsd_rotation_dimension_minus1; i++){ | |
| gsd_min_rotation[ i ] | fl(32) |
| gsd_max_rotation[ i ] | fl(32) |
| } | |
| } | |
| ... | |
| } | |

TABLE 3

| | Descriptor |
|---|---|
| gs_attribute_property( payloadSize ) { | |
| ... | |
| gap_normalized_rotation_flag | u(1) |
| if(gap_normalized_rotation_flag){ | |
| gap_num_rotation_components_minus3 | u(2) |
| } | |

Referring to Tables 2 and 3, it can be seen that the syntaxes gap_normalized_rotation_flag and gap_num_rotation_components_minus3 are included in the attribute property structure of the GS, and the syntax gsd_rotation_present_flag is included in the quantization structure of the GS.

Meanwhile, in Table 3, the syntax gsd_rotation_dimension_minus1 indicates the number of components constituting the rotation information (i.e., the number of dimensions of the rotation information). Specifically, a value obtained by adding 1 to the syntax gsd_rotation_dimension_minus1 may correspond to the number of dimensions of the rotation information.

Meanwhile, the syntax gsd_rotation_dimension_minus1 shall have the same value as the number of dimensions indicated by the syntax element ai_attribute_dimension_minus1 [atlasID][i] for a 2D image in which attribute i in an atlas identified by atlasID represents rotation information.

For each component (i.e., each dimension), a syntax gsd_min_rotation[i] indicating a minimum value among quantized values and a syntax gsd_max_rotation[i] indicating a maximum value among the quantized values may be encoded and signaled.

When the value of the syntax gap_rotation_property_present_flag is 1, the decoder may reconstruct values of the components of the rotation information.

In this case, when the components of the rotation information are normalized by the rotation amount w (i.e., when the value of gap_normalized_rotation_flag is 1), the decoder may reconstruct values of four quaternion components according to Table 4 below.

```
TABLE 4
attrIdx = −1
for( i = 0; i < ai_attribute_count[ RecAtlasID ]; i++ )
  if( ai_attribute_type_id[ RecAtlasID ][ i ] == ATTR_ROTATION ){
    attrIdx = i
    if( gap_normalized_rotation_flag == 1 ){
      if( gap_num_rotation_components_minus3 == 0 ){
    for( n = 0; n < PointCnt; n++ )
```

```
    DeqPcAttr[ n ][ attrIdx ][ 3 ] = 1/sqrt( 1 +
DeqPcAttr[ n ][ attrIdx ][ 0 ] * DeqPcAttr[ n ][ attrIdx ][ 0 ] +
DeqPcAttr[ n ][ attrIdx ][ 1 ] * DeqPcAttr[ n ][ attrIdx ][ 1 ] +
DeqPcAttr[ n ][ attrIdx ][ 2 ] * DeqPcAttr[ n ][ attrIdx ][ 2 ] )
}
for(j= 0; j < 3; j++){
    DeqPcAttr DeqPcAttr[ n ][ attrIdx ][ j ] =
  DeqPcAttr[ n ][ attrIdx ][ j ] *
```

DeqPcAttr[ n ][ attrIdx ][ 3 ]

}

In Table 4, the syntax ai_attribute_type_id[RecAtlasID][i] indicates a component type of a 2D image having attribute index i in an atlas identified by RecAtlasID. That is, ai_attribute_type_id[RecAtlasID][i] being ATTR_ROTATION indicates that the corresponding 2D image relates to rotation information.

PointCnt indicates the number of points (i.e., the number of GSs). DeqPcAttr[n][attrIdx][3] indicates a value of a fourth quaternion component, that is, a value of the variable w. Here, n indicates an n-th point (i.e., an n-th GS).

The fourth quaternion component DeqPcAttr[n][attrIdx][3] may be derived as an inverse of a square root of a sum of a square of a decoded x component DeqPcAttr[n][attrIdx][0], a square of a decoded y component DeqPcAttr[n][attrIdx][1], a square of a decoded z component DeqPcAttr[n][attrIdx][2], and a predefined constant (e.g., 1).

The first to third quaternion components DeqPcAttr[n][attrIdx][j] (j being 0, 1, or 2) may be derived by multiplying a dequantized component value DeqPcAttr[n][attrIdx][j] by the fourth quaternion component value DeqPcAttr[n][attrIdx][3]. Here, the first to third quaternion components may respectively represent x, y, and z.

On the other hand, when the components of the rotation information are not normalized by the rotation amount w (i.e., when the value of gap_normalized_rotation_flag is 0), the decoder may reconstruct the fourth quaternion component according to Table 5 below.

TABLE 5

```
attrIdx = −1
  for( i = 0; i < ai_attribute_count[ RecAtlasID ]; i++ )
    if( ai_attribute_type_id[ RecAtlasID
    ][ i ] == ATTR_ROTATION ){
      attrIdx = i
      if( gap_normalized_rotation_flag == 1 ){
        if( gap_num_rotation_components_minus3 == 0 ){
        for( n = 0; n < PointCnt; n++ )
          DeqPcAttr[ n ][ attrIdx ][ 3 ] = sqrt( 1 −
  DeqPcAttr[ n ][ attrIdx ][ 0 ] * DeqPcAttr[ n ][ attrIdx ][ 0 ] +
  DeqPcAttr[ n ][ attrIdx ][ 1 ] * DeqPcAttr[ n ][ attrIdx ][ 1 ] +
  DeqPcAttr[ n ][ attrIdx ][ 2 ] * DeqPcAttr[ n ][ attrIdx ][ 2 ] )
      }
```

The fourth quaternion component DeqPcAttr[n][attrIdx][3] may be derived as a square root of a value obtained by subtracting a sum of a square of the decoded x component DeqPcAttr[n][attrIdx][0], a square of the decoded y component DeqPcAttr[n][attrIdx][1], and a square of the decoded z component DeqPcAttr[n][attrIdx][2] from a predefined constant (e.g., 1).

Since the first to third quaternion components are not normalized, dequantized component values DeqPcAttr[n][attrIdx][j] of the first to third quaternion components may be directly determined as quaternion component values.

Alternatively, the decoder may process the variable w indicating the rotation amount as having a single value over an entire picture (frame). Specifically, the decoder may set the value of the variable w indicating the rotation amount to a default value over the entire frame.

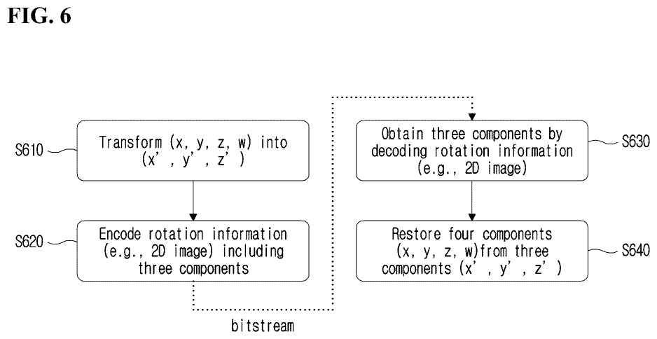

FIG. 6 illustrates an example of encoding/decoding rotation information of GSs according to an embodiment of the present disclosure.

When it is determined to reduce four quaternion components representing rotation information to three components, the encoder may determine whether to normalize the remaining components (x, y, and z) based on the rotation amount w.

Depending on whether the normalization is performed, normalized three components or non-normalized three components may be obtained S610.

Meanwhile, the GS encoder may generate a 2D image having a rotation information attribute and may perform quantization and encoding on the 2D image. Specifically, when four components in a quaternion format are converted into three components, a 2D image having three channels may be generated based on the converted three components.

Converting the four components in the quaternion format into three components may correspond to converting a 2D image having four channels into a 2D image having three channels.

Meanwhile, 2D images of a plurality of attributes may be defined as an atlas having the same identifier.

The GS encoder may encode the converted three components, that is, the 2D image having three channels S620. Specifically, the encoder may perform quantization on the converted three components and entropy-encode quantized component values.

The decoder may decode the 2D image corresponding to the rotation information to reconstruct the three components S630. Specifically, the decoder may decode the quantized component values from the 2D image and perform inverse quantization on the decoded quantized component values, thereby reconstructing values of the three components. Thereafter, the GS decoder may reconstruct four quaternion components from the inverse-quantized three components S640. In this case, depending on whether the three components are normalized, the four quaternion components may be reconstructed according to the examples of Table 4 or Table 5.

According to the present disclosure, a method for encoding and decoding attributes of Gaussian splats (GSs) for representing a three-dimensional space may be provided.

According to the present disclosure, encoding and decoding efficiency may be improved by normalizing rotation information of Gaussian splats (GSs) for encoding and decoding.

The effects of the present disclosure are not limited to those described above, and other effects will be apparent to those skilled in the art from the description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding a Gaussian Splat, the method comprising:
converting rotation information composed of four components of a Gaussian Splat (GS) into three components; and
encoding data including the three components,
wherein the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.

2. The method of claim 1, wherein the three components comprises a converted x component, a converted y component and a converted z component.

3. The method of claim 2, wherein information indicates whether the x component, the y component and the z component are normalized by the w component.

4. The method of claim 3, wherein a normalization is performed by dividing each value of the x component, the y component and the z component by the w component.

5. The method of claim 1, wherein converting the four components into the three components comprises selecting, from a plurality of rotation candidates, a rotation candidate having the greatest value of the w component.

6. The method of claim 5, wherein the plurality of rotation candidates comprises at least one of no rotation, a 90-degree rotation about an x-axis, a 90-degree rotation about a y-axis, or a 90-degree rotation about a z-axis, and
wherein, when a rotation candidate involving rotation is selected, a scale transformation is performed to preserve a shape of the Gaussian splat.

7. The method of claim 1, wherein a value of w is encoded as a constant value.

8. The method of claim 1, wherein information indicating a number of dimensions of the rotation information is encoded and signaled, and
wherein the information has a value equal to a value subtracting a pre-defined constant value from a number of components constituting the rotation information.

9. A method of decoding a Gaussian Splat, the method comprising:
decoding data corresponding to rotation information composed of three components; and
restoring four components of the rotation information from decoded three components,
wherein the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.

10. The method of claim 9, wherein the decoded three components comprise a decoded x component, a decoded y component and a decoded z component.

11. The method of claim 10, wherein information indicating whether the decoded x component, the decoded y component and the decoded z component are normalized.

12. The method of claim 11, wherein when the information indicating that the decoded x component, the decoded y component and the decoded z component are normalized, the x component, the y component and the z component is derived by multiplying the w component to the decoded x component, the decoded y component and the decoded z component, respectively.

13. The method of claim 12, wherein the w component is an inverse of a square root of a sum of a square of the decoded x component, a square of the decoded y component, a square of the decoded z component, and a pre-defined constant value.

14. The method of claim 11, wherein when the information indicates that the decoded x component, the decoded y component and the decoded z component are not normalized, the decoded x component, the decoded y component, and the decoded z component are set as the x component, the y component, and the z component, respectively.

15. The method of claim 14, wherein the w component w is a square root of a value obtained by subtracting a sum of a square of the decoded x component, a square of the decoded y component, and a square of the decoded z component from a predetermined constant.

16. The method of claim 10, wherein the w has a constant value.

17. A non-transitory computer-readable recording medium storing instructions for performing a Gaussian splat encoding method, the method comprising:
converting rotation information composed of four components of a Gaussian Splat (GS) into three components; and
encoding data including the three components,
wherein the four components comprise an x component indicating an x-axis direction of a rotation axis, a y component indicating a y-axis direction of the rotation axis, a z component indicating a z-axis direction of the rotation axis, and a w component indicating a rotation amount about the rotation axis.
